(19) United States
(12) Patent Application Publication
(10) Pub. No.: US 2011/0035892 A1
(43) Pub. Date: Feb. 17, 2011

(54) DEVICE HAVING A HANDLE REGION AND A METHOD FOR MANUFACTURING THE DEVICE

(76) Inventors: Florian Baier, Frankfurt/Main (DE); Roland Heckenthaler, Gabsheim (DE)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/911,228

(22) Filed: Oct. 25, 2010

Related U.S. Application Data
(63) Continuation-in-part of application No. PCT/IB2010/053004, filed on Jun. 30, 2010.

(30) Foreign Application Priority Data
Jul. 3, 2009 (EP) 09 008 741.2

(51) Int. Cl. A46B 5/02; B05D 7/08; B25G 1/00

(52) U.S. Cl. 15/143.1; 427/322; 16/110.1

(57) ABSTRACT

A personal care device having a handle region which at least in part has a surface made of a thermoplastic elastomer provided at least in part with a protective layer of a varnish.

### CROSS REFERENCE TO RELATED APPLICATION

This application is a continuation-in-part application of prior copending International Application No. PCT/IB2010/053004, filed Jun. 30, 2010, designating the United States.

### FIELD OF THE INVENTION

The invention relates to a device having a handle region which, at least in part, has a surface made of a thermoplastic elastomer. The invention also relates to a method for manufacturing the device.

### BACKGROUND OF THE INVENTION

There is a trend for personal devices, for example devices for personal care such as toothbrushes, shavers, or attachments for electric toothbrushes, to exhibit surfaces which at least partially consist of thermoplastic elastomers or to be partially provided with thermoplastic elastomers. Such materials can improve the feel of the device and/or provide an improved anti-slip property when using the device. However, thermoplastic elastomers have the disadvantage of readily becoming contaminated in the course of use. Contamination of the surface occurs particularly in devices which are exhibited as display samples in a shop or business. In this case, the problem exists that as a result of the devices being frequently picked up by many different persons as potential purchasers, the visual appearance of the device (as visible contamination or dirtying) is impaired since in particular the devices as display samples are usually not cleaned (by the sales staff). This is particularly serious with elastomer surfaces that are relatively light in color. This problem could result in a potential purchaser not buying a product.

Devices, in particular presentation devices for an internal goods display are often packaged in a protective film to protect from contaminants. The disadvantage of this, however, is that the protective film may alter the visual appearance and feel of the devices.

Furthermore, there is often a desire to print surfaces of thermoplastic elastomers in order to apply information or symbols. With the previously known printing methods the surface to be printed must in part be expensively pre-treated in order to produce a permanent imprint.

### SUMMARY OF THE INVENTION

A device that comprises a handle region which at least in part includes a surface made of a thermoplastic elastomer, provided at least in part with a protective layer of a polyurethane-based multi-component varnish.

### BRIEF DESCRIPTION OF THE DRAWINGS

Exemplary embodiments of the invention are shown schematically in simplified form and are explained in detail in the following description. In the figures:

FIG. 1 shows various devices or appliances for personal care, which in part have a surface made of a thermoplastic elastomer, which is provided with a protective layer, and

FIG. 2 shows a sectional view of a wall of an appliance casing of a device whose outer surface comprises a thermoplastic elastomer, which is provided in part with a protective layer.

### DETAILED DESCRIPTION OF THE INVENTION

In order to resolve the problems noted herein, it would be desirable to provide a device for personal requirements in which a region of a handle surface consists, at least partially, of a thermoplastic elastomer, wherein the surface of the thermoplastic elastomer is securely protected from contaminants without thereby substantially impairing the feel, the visual appearance and/or the anti-slip properties of the thermoplastic elastomer.

This may be achieved according to the invention by a device for personal requirements having a handle region for manual picking up, wherein the handle region which at least in parts has a surface made of a thermoplastic elastomer (TPE), that is at least in part provided with a protective layer of a varnish. The varnish may be applied directly to the surface of the thermoplastic elastomer, and may be a polyurethane-based multi-component varnish.

The varnish advantageously prevents any adhesion of dirt to the porous surface of the thermoplastic elastomer.

The varnish may be a multicomponent clear varnish, in particular a polyurethane-based two-component clear varnish. The first component of the multi-component clear varnish may be selected from the group comprising a hydroxyl-group-containing polyurethane resin, hydroxyl-group-containing polyester, and polyacrylate, and is cross-linked with a hardener as a second component from the group of polyisocyanates to form a thermosetting polyurethane. As a result, a particularly good adhesion of the varnish on the surface of the thermoplastic elastomer is achieved without needing to separately prepare the surface before applying the varnish.

The two-component clear varnish may include color pigments. In this way, thermoplastic elastomers with colored protective layers are produced.

In one embodiment of the invention, the two-component clear varnish is designed to be highly viscous. As a result, the two-component clear varnish is applied by means of printing methods or the like. If the varnish has color pigments, thermoplastic elastomers with printed surfaces may be produced in an advantageous manner without previous expensive pretreatment of the surface being necessary. The printed surface simultaneously can fulfill the protective function of the protective varnish.

The thickness of the protective layer may be selected so that the anti-slip properties of the plastic are substantially not impaired.

The device may be, for example, a product or an appliance for personal care such as a manual toothbrush, an electric toothbrush, a tongue cleaner attachment, an electric shaver, a epilator or similar.

The surface of the toothbrush neck and/or the toothbrush head and/or the toothbrush handle of a toothbrush having at least one region made of a plastic from the group of thermoplastic elastomers (TPE), wherein the surface of the plastic is coated at least in parts with a protective layer of a varnish.

Furthermore, a method for manufacturing a coated device is provided. The device is made of a plastic from the group of thermoplastic elastomers, wherein the surface of the device is provided at least in part with a protective layer of a varnish and wherein the varnish is applied to the surface of the device within a coating step directly following a device manufacturing step. The varnish is therefore applied directly to the surface of the device. A direct application of the varnish to the surface of the device means that the varnish is applied to the surface of the device without the device or the surface of the device needing to be pretreated, possibly by applying a primer.

The application of the protective layer can be accomplished by spraying, pad printing, screen printing, or flexographic printing. Spraying provides large areas of a TPE surface can advantageously be provided with a varnish. Pad printing can be advantageously used for printing, e.g. using a two-component clear varnish with color pigments.

The method also comprises a step for applying a masking to the TPE surface, wherein this step is executed before applying the protective layer. The regions of the surface of the device or the thermoplastic elastomer not to be provided with a protective layer can be excluded from application of the protective layer by means of the masking.

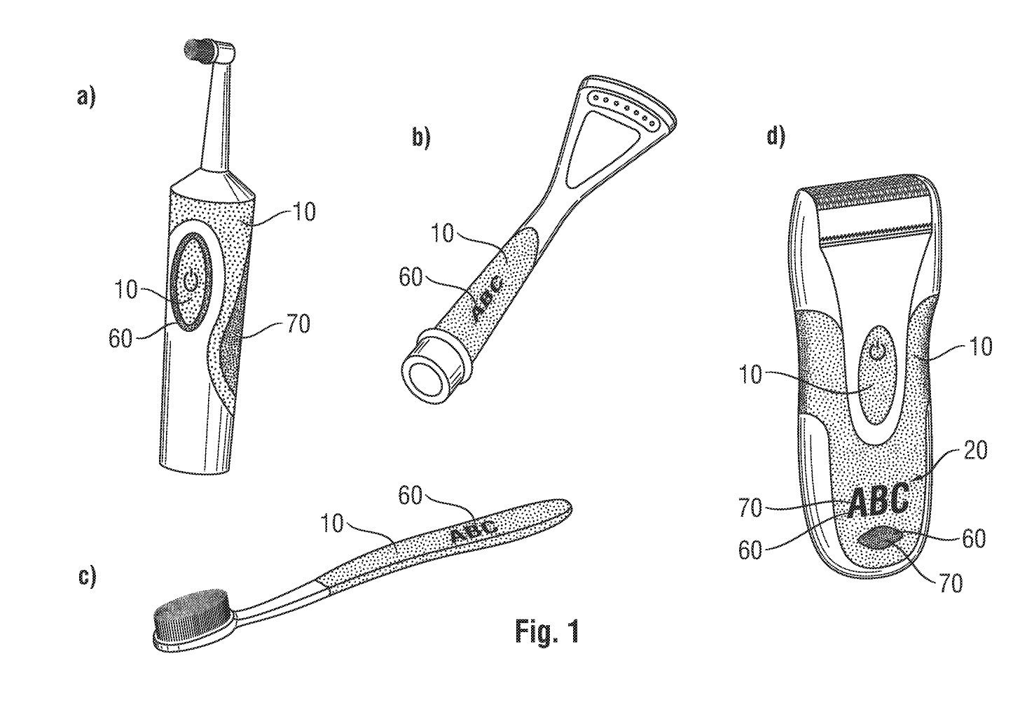

FIG. 1 shows various devices for person care, such as an electric toothbrush (a), a tongue cleaner attachment (b), a manual toothbrush (c), and an electric shaver (d). These devices have a surface which is partially provided with a plastic or which consists partially of a plastic. The plastic in this case is a plastic from the group of thermoplastic elastomers (TPE). The surfaces of the devices thus formed are represented by the dotted areas in FIG. 1. The surface not provided with the thermoplastic elastomer, if any, can possibly be made of a hard plastic (such as, for example, PP, PE, or POM), a metal, or any other suitable material. The personal care device may be produced in a multicomponent injection process (hard/soft) or any other process.

The surfaces formed from a thermoplastic elastomer primarily have the task of providing a haptically pleasant and at the same time slip-inhibiting surface. That region of the surface of an device, which is touched by the user when using the device in order to securely grip and hold the device, may be provided with a thermoplastic elastomer.

As a result of the elastic properties of the thermoplastic elastomer, a surface covered with a thermoplastic elastomer may extend over movable parts of an appliance, possibly over a switch for switching the appliance on and off. The switch can be actuated through the surface.

In order to protect the surfaces of the thermoplastic elastomer, in particular the visible surfaces, from contaminants, a protective layer 10 of a varnish is applied to the surface of the thermoplastic elastomer. The varnish may be a polyurethane-based two-component clear varnish so that the surface of the thermoplastic elastomer lying under the varnish can still be identified.

By optionally adding color pigments to the varnish, the surface may be at least in part with a colored protective layer.

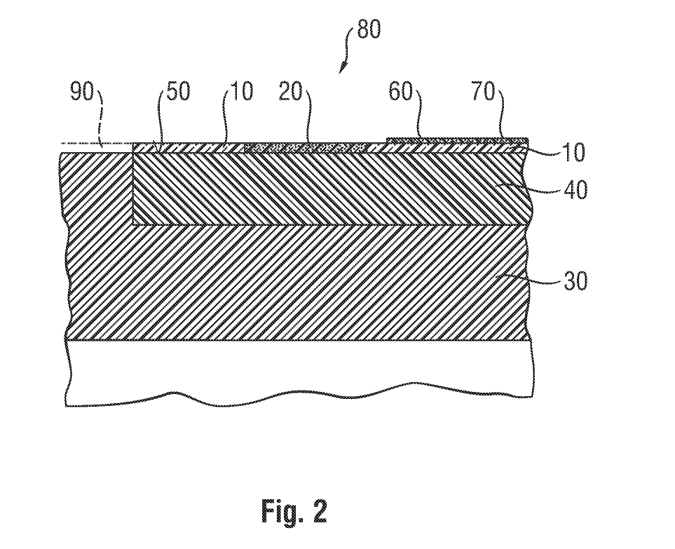

FIG. 2 shows a wall 30 of an appliance casing of a device in a sectional view, wherein the outer surface or the outer side 80 of the casing completely or partially comprises a thermoplastic elastomer 40, which is completely or partially provided with a protective layer 10.

A thermoplastic elastomer 40 is applied to the surface of the appliance wall 30, which consists, for example, of a hard plastic. The thickness and shape of the thermoplastic elastomer are substantially dependent on the function to be fulfilled. Movable regions of the surface or the region which are subjected to a high stressing are optionally provided with a substantially thicker layer of a thermoplastic elastomer.

As can be seen from FIG. 2, the thermoplastic elastomer 40 may be disposed in the appliance wall 30 so that a substantially flush surface is obtained between the thermoplastic elastomer 40 and the appliance wall 30. The thermoplastic elastomer can alternatively be applied to the appliance wall 30 without terminating flush to the appliance wall 30.

The surface 50 of the thermoplastic elastomer 40 is either completely or partially covered with a protective varnish 10. The clear varnish is applied directly to the surface of the thermoplastic elastomer 40 without needing to pretreat the surface. A protective layer 10 is formed and thus prevents the adhesion of dirt to the surface of the thermoplastic elastomer.

In this case, the protective varnish 10 is applied directly to the surface of the thermoplastic elastomer 40 without any pretreatment, possibly applying a primer, of the surface of the thermoplastic elastomer 40 being required previously. The process of manufacturing coated components made of thermoplastic elastomers is therefore speeded up considerably.

Depending on the mechanical requirements on the protective layer, e.g. in regions which are touched frequently or in movable regions in which the thermoplastic elastomer frequently undergoes a mechanical deformation (e.g. in the case of switches located thereunder), the layer thickness of the applied protective varnish can range from a few μm to several mm.

If a two component varnish is used, the first component of the two-component varnish may be selected from the group comprising hydroxyl-group-containing polyurethane resin, hydroxyl-group-containing polyester, and polyacrylate, and is cross-linked with a hardener from the group of polyisocyanates to form a thermosetting polyurethane. A reliable adhesion of the two-component clear varnish on the thermoplastic elastomer is thus achieved. A particularly good adhesion is achieved with a two-component varnish with isocyanate. A thinner may be added to the varnish before application.

By using the clear varnish, the visual appearance and the feel of the thermoplastic elastomer are only changed insignificantly. The anti-slip property of the elastomer is substantially retained. Further, due to the coating, the surface of the thermoplastic elastomer is hydrophobized, i.e. a water-repellant surface is formed so that water drips off. The substrate or the surface of the elastomer is furthermore protected by the protective varnish formed in a thermosetting manner (chemically cross-linked). Specifically mat and/or rough (porous) surfaces of thermoplastic elastomers are liable to dirt deposits. A mat protective varnish having the said composition significantly reduces the uptake of dirt by the barrier effect (mechanical and chemical), which is particularly advantageous in regard to the hygiene of the care product.

By adding color pigments to the clear varnish, it is also possible to apply colored protective varnishes to the elastomer surface. A region comprising two-component clear varnish mixed with color pigments is shown by the reference numeral 20 in FIG. 2.

By adding color pigments to the clear varnish, it is also possible to apply symbols, information, or the like to the surface of the thermoplastic elastomer. In addition to the protective effect of the two-component clear varnish, information is thereby provided at the same time on the elastomer surface.

The clear varnish may be applied by means of a spraying method. Specific regions of the elastomer surface 50 may be excluded from the coating by means of a masking, as can also be seen in FIG. 2, where the left region of the surface 50 of the thermoplastic elastomer 40 has no protective layer 10. The masking also serves to exclude surfaces not consisting of a thermoplastic elastomer from the coating. This is particularly advantageous when the protective varnish 10 is only applied or intended to be applied after applying the thermoplastic elastomer to the device or to the appliance.

The protective varnish may be applied by spraying, injection, or dipping. Alternatively, the protective varnish may be applied by pad printing, screen printing, or flexographic printing. To this end, the protective varnish or the protective varnish provided with the color pigments may be designed to be highly viscous. On the one hand the protective effect of the protective varnish is thereby selectively restricted to small areas, possibly elastic switch regions, on the other hand, for example, information and/or symbols and/or individual colorings/color decorations are additionally applied to the surface of the thermoplastic elastomer 40, as shown as “ABC” with reference numeral 20 in the device (d) in FIG. 1.

The information and/or symbols and/or individual colorings/color decorations are optionally also designed as an imprint 60 or as another protective layer 70 on the protective layer 10. To this end, the protective varnish 10 may be configured as a printing ink, which is provided with a corresponding viscosity and with corresponding color pigments, wherein in addition to the spraying method, the printing ink is optionally applied by pad printing, screen printing, or flexographic printing.

Optionally, a corresponding protective layer 10 may be provided over the thermoplastic surface 50 so that in extreme cases, the entire surface is provided with the protective layer 10, which makes any masking superfluous. This is indicated schematically by the dashed line with the reference numeral 90 in FIG. 2.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “20 μm” is intended to mean “about 20 μm”.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A device comprising a handle region which includes a surface, at least a portion of which is made of a thermoplastic elastomer, the thermoplastic elastomer provided at least in part with a protective layer of a polyurethane-based multi-component varnish.

2. The device according to claim 1, wherein the varnish is a two-component varnish having a first component and a second component.

3. The device according to claim 2, wherein the first component of the two-component varnish is selected from the group comprising a hydroxyl-group-containing binder and is cross linked with a hardener as second component.

4. The device according to claim 2, wherein the binder comprises a polyurethane resin or polyester or polyacrylate.

5. The device according to claims 3, wherein the hardener is cross-linked on the basis of polyisocyanates to form a thermosetting polyurethane.

6. The device according to claim 1, wherein the thickness of the protective layer is 8 to 100 μm and in particular 20 to 60 μm.

7. The device according to claim 1, wherein the device is an electric toothbrush, a tongue cleaner attachment, mouth care product, an electric shaver, or an epilator.

8. The device according to claim 1, wherein the device is a toothbrush with a toothbrush neck, a toothbrush head, and a toothbrush handle, wherein the surface of the toothbrush neck and/or the toothbrush head and/or the toothbrush handle has at least one region made of the thermoplastic elastomer and wherein the region is provided with the varnish protective layer.

9. A method for protecting at least a portion of a personal care product which is produced by injection molding comprising:
providing a personal care product with at least one section including a thermoplastic elastomer; and
providing a protective varnish on at least a part of the thermoplastic elastomer.

10. The method according to claim 9, wherein the protective varnish is a polyurethane-based two-component clear varnish, and wherein one component of the varnish is selected from the group comprising hydroxyl-group-containing polyurethane resin, hydroxyl-group-containing polyester, and polyacrylate, and as a second component is cross-linked with a hardener from the group of polyisocyanates to form a thermosetting polyurethane.

11. The method according to claim 9, wherein the protective varnish is provided by spraying, dipping, injection or printing.

12. The method according to claim 9, wherein at least a portion of the personal care product is masked so as to not be provided with the protective varnish.
